(19) United States
(12) Patent Application Publication
(10) Pub. No.: US 2026/0153148 A1
(43) Pub. Date: Jun. 4, 2026

(54) AIRTIGHT MEMBER WITH FLUOROELASTOMER SEAL AND MANUFACTURING METHOD THEREOF

(71) Applicant: GREATLY INC., Taoyuan City (TW)

(72) Inventor: YU FEN LIN, Taoyuan City (TW)

(21) Appl. No.: 18/968,268

(22) Filed: Dec. 4, 2024

(51) Int. Cl. F16J 15/3284; B29C 43/18; B29C 43/36; B29K 27/12; B29L 31/26

(52) U.S. Cl. CPC F16J 15/3284; B29C 43/18; B29C 43/36; B29K 2027/12; B29L 2031/26

(57) ABSTRACT

An airtight member with a fluoroelastomer seal and a manufacturing method thereof are disclosed. The fluoroelastomer seal is formed and bonded to a base surface of a main body of the airtight member by hot pressing. The main body of the airtight member is held by a main mold. A pre-pressed fluoroelastomer material is pressurized by a forming cavity of a forming mold and heated to form the fluoroelastomer seal bonded to the base surface. The airtight member and the fluoroelastomer seal are combined to form an integrated structure, which is beneficial for assembly and disassembly and has good sealing effect.

### FIELD OF THE INVENTION

The present invention relates to an airtight member, and more particularly, to an airtight member with a fluoroelastomer seal and a manufacturing method thereof.

### BACKGROUND OF THE INVENTION

Plasma, also known as ionized gas, is the fourth state of matter following solid, liquid and gas. It is usually generated under the conditions of high temperature and electric fields. The high-energy ions/electrons, or reactive radicals produced by plasma can remove contaminants or deactivate substances on the sample surface, or generate functional groups on the sample surface. Modern technology often utilizes the unique properties of plasma for surface modification or cleaning of samples, such as in surface etching, surface cleaning, surface activation, and so on.

As plasma etching is a precise and controlled process, it is commonly used in the semiconductor industry for etching complex patterns on wafers. The sealing components of the equipment used are required to withstand special environments, such as high and low temperatures, strong acids, and strong alkalis. In general, plasma etching of wafers involves placing the wafer to be processed in a plasma chamber, where a gas distribution system introduces a suitable combination of gases into the plasma chamber. After plasma etching, a deposit layer is often formed on the inner wall of the plasma chamber, which often requires disassembly of the plasma chamber for cleaning or replacement. However, the sealing elements for the plasma chamber are small in size, and it is often difficult to reinstall them correctly after maintenance. Even slight deviations will hinder correct installation and layout, affecting the overall airtightness of the plasma chamber.

China Utility Model Publication No. CN203225223 discloses a ceramic lateral gas nozzle. The ceramic lateral gas nozzle has eight mounting holes that are arranged symmetrically. The ceramic lateral gas nozzle is mounted in any one of the mounting holes. The mounting holes are located on the side wall of the top interface of a plasma reaction chamber capable of processing semiconductor substrates. As shown in FIG. 5G and FIG. 5I of the description of this patent, the lateral gas nozzle extends to the plasma reaction chamber via the corresponding mounting hole. Gaskets are provided on both end faces of the lateral gas nozzle to ensure tightness between the lateral gas nozzle and the corresponding mounting hole, so as to ensure the airtightness of the plasma reaction chamber. However, during routine maintenance and damage replacement, the gasket placed between the lateral gas nozzle and the mounting hole is difficult to remove and replace because it is pressed for a long time. Even if the lateral gas nozzle is removed, it is difficult to place the gasket due to the small mounting hole. Besides, the components are small and difficult to align accurately. Even slight operational mishandling will affect the airtightness of the plasma reaction chamber. They need to be dismantled and reinstalled, resulting in time-consuming and inefficient maintenance that affects productivity.

### SUMMARY OF THE INVENTION

The primary object of the present invention is to provide an airtight member with a fluoroelastomer seal. The airtight member has its own fluoroelastomer seal, which reduces the installation process and shortens the maintenance time, and improves maintenance and replacement efficiency.

Another object of the present invention is to provide a manufacturing method of an airtight member with a fluoroelastomer seal, which uses a main mold for holding a main body of the airtight member and a forming mold for molding a pre-pressed fluoroelastomer material by hot pressing to form the fluoroelastomer seal bonded to a base surface of the airtight member. The fluoroelastomer seal is integrated with the airtight member, which facilitates installation and replacement to improve maintenance efficiency.

In order to achieve the primary object of the present invention, an airtight member is provided. The airtight member comprises a main body and a fluoroelastomer seal. Either end of the main body in an axial direction has a base surface. The base surface is perpendicular to the axial direction. An outer contour is formed along an outer peripheral edge of the base surface. The fluoroelastomer seal is attached to the base surface by hot pressing and located within the outer contour. A distance is defined between an outer peripheral side of the fluoroelastomer seal and the outer contour. The fluoroelastomer seal has a height from the base surface to a top surface of the fluoroelastomer seal.

In order to achieve another object of the present invention, a manufacturing method of the foregoing airtight member is provided. The manufacturing method comprises the steps of:
the main body of the airtight member being placed into a through hole of a main mold, the airtight member being held by the main mold, the base surface of the airtight member and a contact surface of the main mold being located at a same side;
a pre-pressed fluoroelastomer material being placed on the base surface or a molding surface of a forming mold, the molding surface and the contact surface being moved to come into contact with each other, the pre-pressed fluoroelastomer material being pressurized by a forming cavity recessed on the molding surface for the pre-pressed fluoroelastomer material to fill the forming cavity and to be molded between the forming cavity and the base surface, the remaining material of the pre-pressed fluoroelastomer material overflowing to an overflow space, the forming mold being heated to form the fluoroelastomer seal bonded to the base surface.

### BRIEF DESCRIPTION OF THE DRAWINGS

FIG. 1 is a longitudinal sectional view of the airtight member of the present invention;

FIG. 2 is a longitudinal sectional view of the main mold and the forming molds used for manufacturing the airtight member of the present invention;

FIG. 3 is a partial, enlarged, longitudinal sectional view of the main mold and the forming molds of the present invention;

FIG. 4 is an exploded, longitudinal sectional view of the main body of the airtight member and the lower forming mold of the present invention;

FIG. 5 is a partial, longitudinal sectional view of the present invention, illustrating that the main body of the airtight member is held by the main mold;

FIG. 6 is a longitudinal sectional view of the present invention, illustrating that the pre-pressed fluoroelastomer material is placed on the base surface of the main body;

FIG. 7 is a longitudinal sectional view of the present invention, illustrating that the upper forming mold is against the main mold;

FIG. 8 is a partial, enlarged, longitudinal sectional view of the present invention, illustrating that the pre-pressed fluoroelastomer material is placed on the base surface of the main body;

FIG. 9 is a partial, enlarged, longitudinal sectional view of the present invention, illustrating that the pre-pressed fluoroelastomer material overflows from the forming cavity; and

FIG. 10 is a partial, enlarged, longitudinal sectional view of the present invention, illustrating that the annular outer peripheral wall is completely against the base surface.

### DETAILED DESCRIPTION OF THE PREFERRED EMBODIMENTS

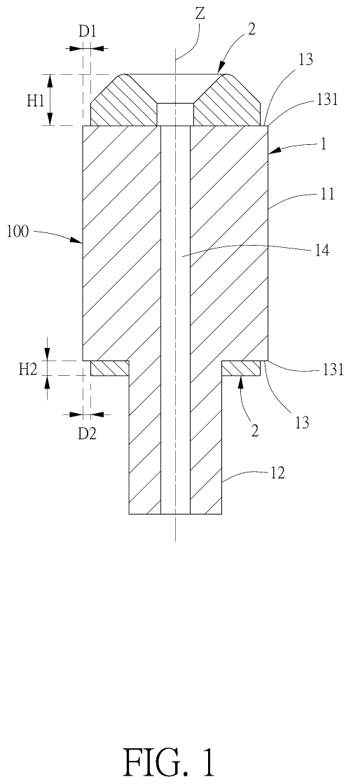

FIG. 1 illustrates an airtight member with a fluoroelastomer seal according to a preferred embodiment of the present invention. The airtight member 100 comprises a main body 1 and at least one fluoroelastomer seal 2 bonded to the main body 1 by hot pressing. The main body 1 may be made of ceramics, quartz glass (SiO₂), sapphire glass (Al₂O₃), metal, etc. In this embodiment, the main body 1 is a ceramic nozzle used in a semiconductor plasma processing device as an example.

The airtight member 100 has a ceramic air nozzle 1. Either end of the ceramic air nozzle 1 in an axial direction Z has a base surface 13. In this embodiment, the ceramic air nozzle is a stepped cylinder composed of an upper segment 11 and a lower segment 12. The diameter of the upper segment 11 is greater than the diameter of the lower segment 12. The upper segment 11 and the lower segment 12 have a central hole 14 passing through the ceramic air nozzle 1 in the same axial direction Z. One end of the upper segment 11, connected to the lower segment 12, has a base surface 13. Another end of the upper segment 11, opposite to the lower segment 12, also has a base surface 13. Both the two base surfaces 13 are perpendicular to the axial direction Z. An outer contour 131 is formed along the outer peripheral edge of each of the base surfaces 13. The fluoroelastomer seal 2 is bonded to each of the two base surfaces 13 by hot pressing.

Furthermore, the fluoroelastomer seal 2 is an annular structure. A distance is defined between the outer peripheral side of the fluoroelastomer seal 2 and the outer contour 131. The distance ranges from 0.25 mm to 0.55 mm. The fluoroelastomer seal 2 has a height from the base surface 13 to the top surface of the fluoroelastomer seal 2. The height ranges from 0.42 mm to 1.85 mm. In addition, the fluoroelastomer seal 2 may have a semi-circular, triangular, rectangular, trapezoidal or hill-shaped longitudinal section in the axial direction Z. In this embodiment, the fluoroelastomer seal 2 bonded to the base surface 13 at the end of the upper segment 11, connected to the lower segment 12, has a rectangular longitudinal section. The fluoroelastomer seal 2 bonded to the base surface 13 at the end of the upper segment 11, opposite to the lower segment 12, has a hill-shaped longitudinal section.

The fluoroelastomer seal 2 is made of fluoroelastomer (FKM) or perfluoroelastomer (FFKM). The fluoroelastomer (FKM) may be selected from at least one of the group consisting of vinylidene fluoride (VDF) and hexafluoropropylene (HFP) fluorine rubber; vinylidene fluoride (VDF), hexafluoropropylene (HFP) and tetrafluoroethylene (TFE) fluorine rubber; vinylidene fluoride (VDF), tetrafluoroethylene (TFE) and perfluoromethylvinylether (PMVE) fluorine rubber; propylene, tetrafluoroethylene (TFE) and vinylidene fluoride (VDF) fluorine rubber; and vinylidene fluoride (VDF), hexafluoropropylene (HFP), tetrafluoroethylene (TFE) and perfluoromethylvinylether (PMVE) fluorine rubber. The perfluoroelastomer (FFKM) may be selected from at least one of the group consisting of tetrafluoroethylene (TFE), hexafluoroethylene (HFP), perfluoromethylvinylether (PMVE) and chlorotrifluoroethylene (CTFE). The fluoroelastomer seal 2 made of fluoroelastomer (FKM) or perfluoroelastomer (FFKM) has good high-temperature resistance, which not only provides the required mechanical strength and modulus but also has good chemical and plasma resistance, and long service life, and is suitable for the semiconductor industry. In this embodiment, both the fluoroelastomer seals 2 are made of perfluoroelastomer (FFKM).

The fluoroelastomer seal 2 of the airtight member 100 provided by the embodiment of the present invention is bonded to each of the two base surfaces 13 of the ceramic air nozzle 1 by hot pressing, forming an integral structure. When the ceramic air nozzle 1 is mounted in the mounting hole, the fluoroelastomer seal 2 is in close contact with the bottom of the mounting hole of the equipment to achieve a better sealing effect. The integrated structure facilitates installation and disassembly, improving equipment maintenance efficiency.

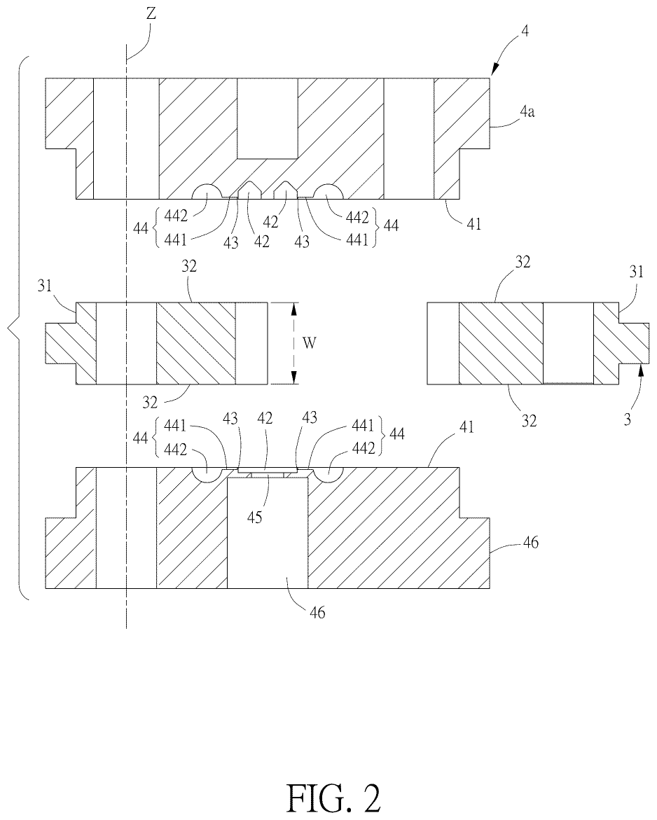

The present invention further provides a manufacturing method of an airtight member with a fluoroelastomer seal. Please refer to FIG. 2 through FIG. 7. The manufacturing method needs a main mold 3 and at least one forming mold 4. A pre-pressed fluoroelastomer material 5 is attached to the base surface 13 of the ceramic air nozzle 1 of the airtight member 100 by hot pressing through the main mold 3 and the forming mold 4 to come into contact with each other.

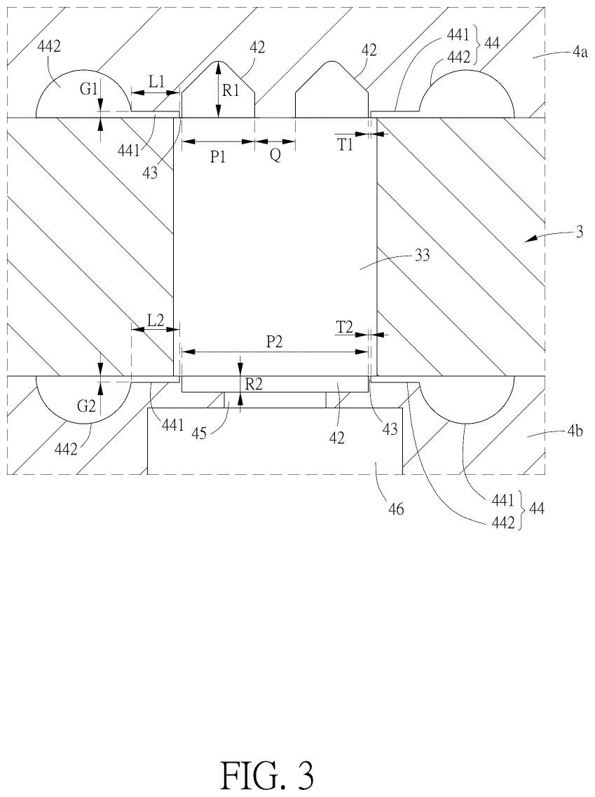

Furthermore, as shown in FIG. 2 and FIG. 3, the production of the airtight member with a fluoroelastomer seal of the above embodiment needs a main mold 3 and two forming molds 4. The main mold 3 includes left and right mold bodies 31 that are symmetrical and can be aligned and closed. After the two mold bodies 31 are aligned and closed, a through hole 33 is formed for accommodating the main body 1 of the airtight member 100. In particular, the inner diameter of the through hole 33 is slightly greater than the outer diameter of the portion of the main body 1 surrounded by the through hole 33, which can avoid direct pressure on the main body 1 to cause damage to the main body 1 and ensure that the inner peripheral wall of the through hole 33 surrounds the outer peripheral wall of the main body 1, so as to achieve the effect of fixation. After the two mold bodies 31 are aligned and closed, two opposite contact surfaces 32 are formed for abutting against molding surfaces 41 of the two forming molds 4. After the main body 1 of the airtight member 100 is placed in the through hole 33, the base surface 13 of the main body 1 is 0.5 μm to 5 μm higher than the contact surface 32 to ensure that the pre-pressed fluoroelastomer material 5 is formed on the base surface 1 when the molding surface 41 and the contact surface 32 come into contact with each other.

As shown in FIG. 3, when the airtight member of the above embodiment is manufactured and when the upper segment 11 of the main body 1 is clamped in the through hole 33 by the two mold bodies 31 while lower segment 12 extends out of the through hole 33.

Referring to FIG. 2, the two forming molds 4 of this embodiment are defined as an upper forming mold 4a and a lower forming mold 4b. An annular forming cavity 42 and an overflow space 44 are concavely formed on the molding surface 41 of the upper forming mold 4a. The forming cavity 42 is separated from the overflow space 44 by an annular outer peripheral wall 43. An annular forming cavity 42 and an overflow space 44 are also concavely formed on the molding surface 41 of the lower forming mold 4b. The forming cavity 42 is separated from the overflow space 44 by an annular outer peripheral wall 43. A retaining hole 45 is formed in the center of the forming cavity 42 of the lower forming mold 4b. The retaining hole 45 communicates with an accommodating cavity 46 having an opening opposite to the molding surface 41. The lower segment 12 of the main body 1 of the airtight member 00 passes through the retaining hole 45 and extends into the accommodating cavity 46 to assist in retaining the main body 1.

As shown in FIG. 3, the thickness of the annular outer peripheral wall 43 ranges from 0.07 mm to 0.50 mm. The forming cavity 42 may have a semi-circular, triangular, rectangular, trapezoidal or hill-shaped longitudinal section in the axial direction. The maximum depth of the forming cavity 42 is between 0.45 mm and 1.87 mm, and the maximum width of the forming cavity 42 is between 1.01 mm and 2.35 mm. In this embodiment, the forming cavity 42 of the upper forming mold 4a has a hill-shaped longitudinal section, and the forming cavity 42 of the lower forming mold 4b has a rectangular longitudinal section. In particular, when the upper forming mold 4a and the lower forming mold 4b come into contact with the main mold 3, the annular outer peripheral walls 43 are against the base surfaces 13 of the main body 1. The inner diameter Q of the forming cavity 42 of the upper forming mold 4a is greater than the diameter of the center hole 14 of the main body 1, which can prevent the pre-pressed fluoroelastomer material 5 in the forming cavity 42 from being extruded into the central hole 14 to affect the sealing effect of the pre-pressed fluoroelastomer material after molding.

Furthermore, as shown in FIG. 2 and FIG. 3, the overflow spaces of the upper forming mold 4a and the lower forming mold 4b are arranged around the annular outer peripheral walls 43, respectively. The overflow space has an overflow channel 441 and a storage cavity 442. The overflow channel 441 is located between the annular outer peripheral wall 43 and the storage cavity 442. The overflow channel 441 communicates with the storage cavity 442. The length of the overflow channel 441 ranges from 1.5 mm to 1.9 mm, and the height of the overflow channel 441 ranges from 0.10 mm to 0.3 mm. The overflow channel 441 increases the spatial resistance of the pre-pressed fluoroelastomer material 5 overflowing into the storage cavity 442, reduces the pressure difference between the forming cavity 42 and the storage cavity 442, and ensures that the pre-pressed fluoroelastomer material is pressurized to completely fill the forming cavity 42.

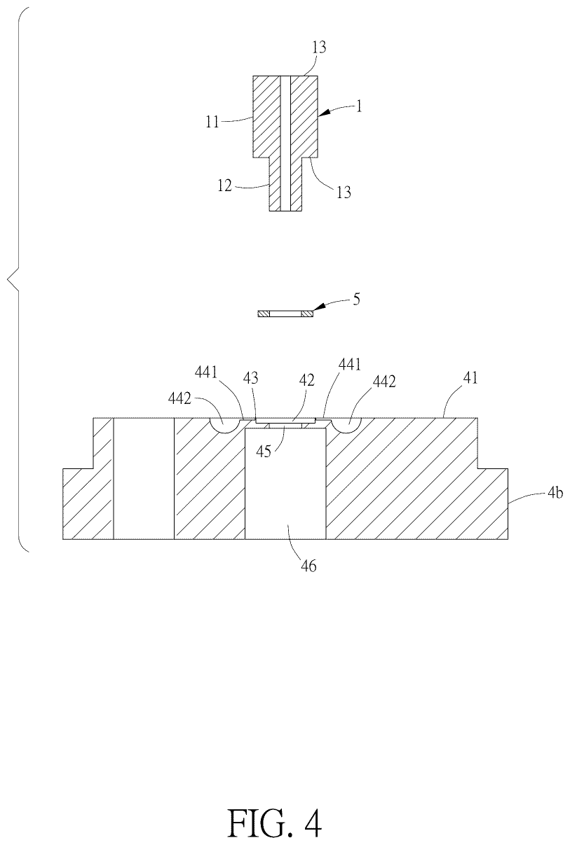

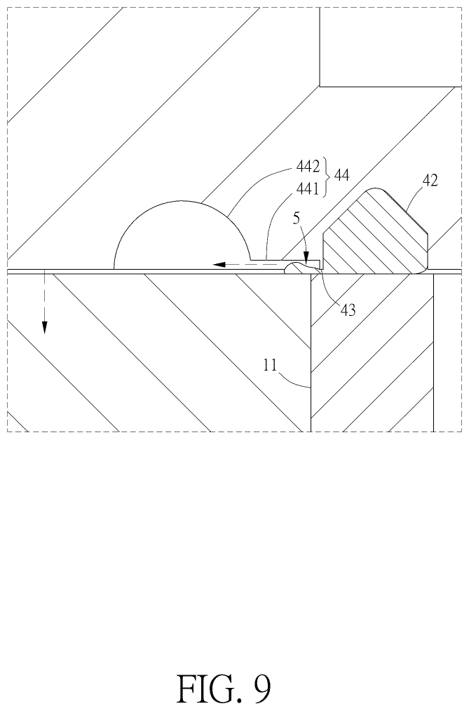

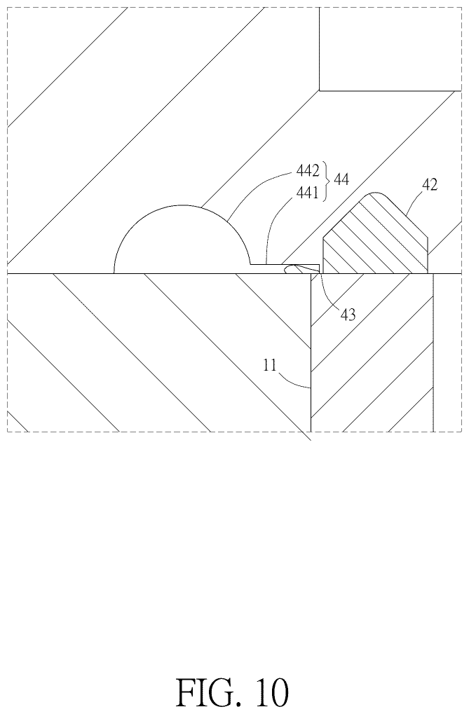

Referring to FIG. 4 through FIG. 10, in conjunction with the structure and description of the main mold and the forming molds shown in FIG. 2 and FIG. 3, the manufacturing method is described in detail below.

As shown in FIG. 3 through FIG. 7, the main body 1 of the airtight member 100 is placed into the through hole 33 of the main mold 3. The airtight member 100 is held by the main mold 3, and the base surface 13 of the airtight member 100 and the contact surface 32 of the main mold 3 are located at the same side. The pre-pressed fluoroelastomer material is placed on the base surface 13 or the molding surface 41 of the forming mold 4. The molding surface 41 and the contact surface 32 are moved to come into contact with each other. The pre-pressed fluoroelastomer material 5 is pressurized by the forming cavity 42 recessed on the molding surface 41 for the pre-pressed fluoroelastomer material 5 to fill the forming cavity 42 and to be molded between the forming cavity 42 and the base surface 13. The remaining material overflows to the overflow space 44 and is heated to a temperature of 130° C. to 250° C. by the forming mold and kept at a constant temperature for 3 to 15 minutes to form the fluoroelastomer seal 2 bonded to the base surface 13.

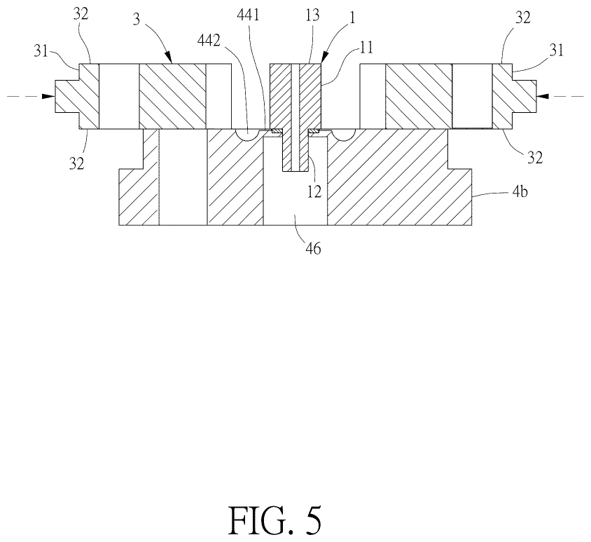

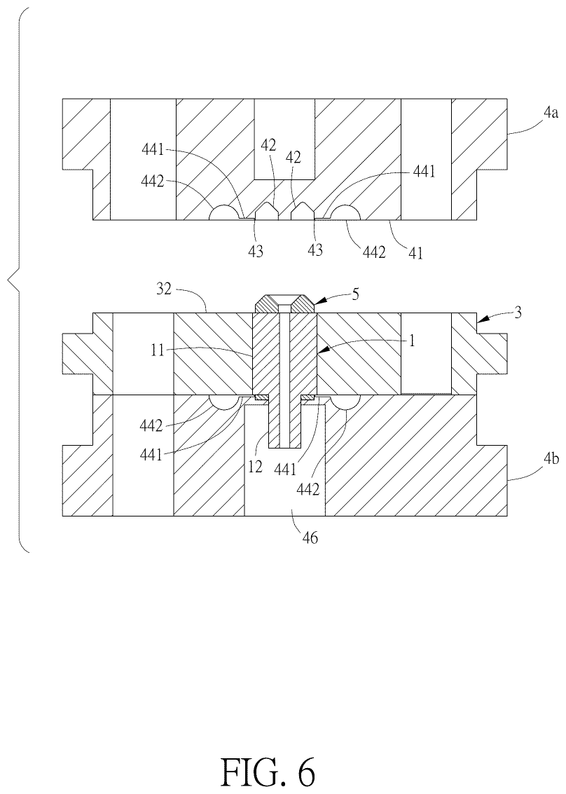

According to the above-mentioned manufacturing method, the main body of the airtight member is a ceramic air nozzle as an example for detailed explanation. As shown in FIG. 4, first, the pre-pressed fluoroelastomer material 5 is placed in the forming cavity 42 of the lower forming mold 4b. The lower segment 12 of the ceramic air nozzle 1 of the airtight member 100 is inserted into the retaining hole 45 and extends into the accommodating cavity 46. As shown in FIG. 5, after the two mold bodies 31 of the main mold 3 are aligned and closed, the upper segment 11 of the main body 1 is in the through hole 33 of the two mold bodies 31. As shown in FIG. 6, another pre-pressed fluoroelastomer material 5 is placed on the base surface 13 of the upper segment 11 of the ceramic air nozzle 1, opposite to the lower segment 12.

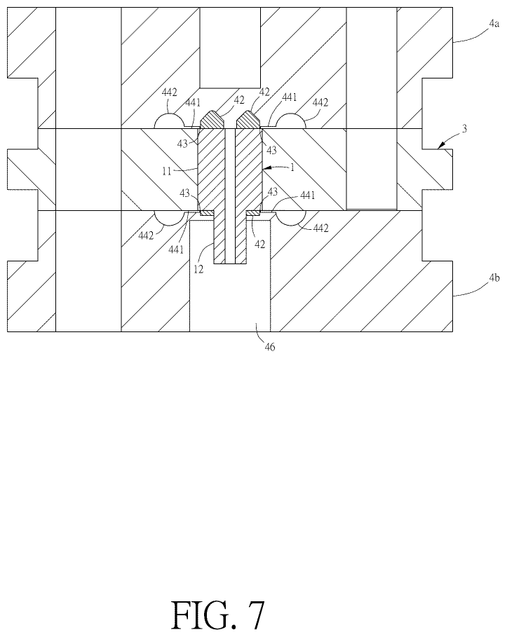

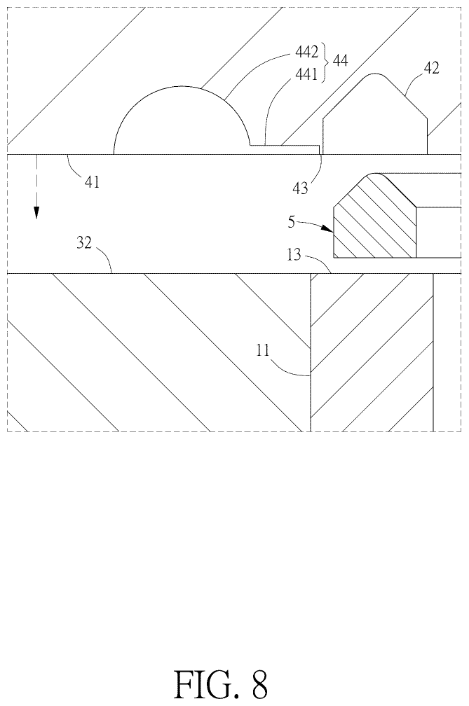

As shown in FIG. 7, after the molding surface 41 of the upper forming mold 4a is in contact with the contact surface 32 of the main mold 3, the upper forming mold 4a applies a downward force to the main mold 3. At this time, as shown in FIGS. 8 to 10, the pre-pressed fluoroelastomer material 5 is pressurized to fill the forming cavity 42. The remaining material overflows through the overflow channel 441 into the storage cavity 442 until the annular outer peripheral walls 43 of both the upper forming mold 4a and the lower forming mold 4b are against the base surfaces 13 of the main body 1, i.e., the preliminary pressurized molding is completed. The upper forming mold 4a and the lower forming mold 4b are heated to a temperature of 180° C. for 8 minutes to form the fluoroelastomer seal 2 bonded to the base surface 13 of the ceramic nozzle 1.

In particular, the pre-pressed fluoroelastomer material 5 is made of fluoroelastomer (FKM) or perfluoroelastomer (FFKM), and is pre-pressed into a ring shape. The volume of the pre-pressed fluoroelastomer material 5 is 2% to 5% greater than that of the forming cavity 42 to ensure that the forming cavity is completely filled with the pre-pressed fluoroelastomer material 5 after pressurization. In this embodiment, the volume of the pre-pressed fluoroelastomer material 5 is 4% greater than that of the forming cavity 42.

The airtight member with the fluoroelastomer seal and the manufacturing method provided by the present invention have the following technical advancements and advantages:
Firstly, the fluoroelastomer seal and the airtight member form an integrated structure, which is easy to assemble, disassemble and take out. In the present invention, the pre-pressed fluoroelastomer material is attached to the base surface of the airtight member through a forming mold by hot pressing, such that the fluoroelastomer seal is formed and bonded to the base surface of the airtight member to form an integrated structure. When being assembled or removed, the airtight member and the fluoroelastomer seal are put in or taken out together, which solves the problem that the fluoroelastomer seal is too small and is not easy to be taken out or placed in during disassembly or installation, thereby improving the maintenance efficiency.

Secondly, the airtight member can be held stably by the main mold and can be demolded easily. The main mold includes two symmetrical mold bodies that can be aligned and closed. After the two symmetrical mold bodies are aligned and closed, the inner peripheral wall of the through hole surrounds the outer peripheral wall of the main body, so that the fluoroelastomer seal is accurately formed on the base surface of the airtight member. The inner diameter of the through hole is slightly greater than the outer diameter of the main body surrounded by the through hole. When the forming mold is in contact with the main mold, even if part of the pre-pressed fluoroelastomer material is pressurized to pass through the gap between the through hole and the main body, the assembled main mold can be opened easily to take out the airtight member, thus reducing the difficulty of demolding.

Thirdly, the risk of contact leakage at the junction is reduced. The fluoroelastomer seal of the present invention is bonded to the base surface of the airtight member. After assembly, the fluoroelastomer seal is tightly bonded at the junction with a high degree of tightness, which reduces the risk of contact leakage at the junction.

1. An airtight member, comprising:
a main body, either end of the main body in an axial direction having a base surface, the base surface being perpendicular to the axial direction, an outer contour being formed along an outer peripheral edge of the base surface;
a fluoroelastomer seal, formed and attached to the base surface by hot pressing and located within the outer contour, a distance being defined between an outer peripheral side of the fluoroelastomer seal and the outer contour, the fluoroelastomer seal having a height from the base surface to a top surface of the fluoroelastomer seal.

2. The airtight member as claimed in claim 1, wherein the fluoroelastomer seal is made of fluoroelastomer (FKM) or perfluoroelastomer (FFKM).

3. The airtight member as claimed in claim 2, wherein the fluoroelastomer (FKM) is selected from at least one of the group consisting of vinylidene fluoride (VDF) and hexafluoropropylene (HFP) fluorine rubber; vinylidene fluoride (VDF), hexafluoropropylene (HFP) and tetrafluoroethylene (TFE) fluorine rubber; vinylidene fluoride (VDF), tetrafluoroethylene (TFE) and perfluoromethylvinylether (PMVE) fluorine rubber; propylene, tetrafluoroethylene (TFE) and vinylidene fluoride (VDF) fluorine rubber; and vinylidene fluoride (VDF), hexafluoropropylene (HFP), tetrafluoroethylene (TFE) and perfluoromethylvinylether (PMVE) fluorine rubber.

4. The airtight member as claimed in claim 2, wherein the perfluoroelastomer (FFKM) is selected from at least one of the group consisting of tetrafluoroethylene (TFE), hexafluoroethylene (HFP), perfluoromethylvinylether (PMVE) and chlorotrifluoroethylene (CTFE).

5. The airtight member as claimed in claim 1, wherein the distance ranges from 0.25 mm to 0.55 mm, and the height ranges from 0.42 mm to 1.85 mm.

6. The airtight member as claimed in claim 1, wherein the fluoroelastomer seal is an annular structure, and the fluoroelastomer seal has a semi-circular, triangular, rectangular, trapezoidal or hill-shaped longitudinal section in the axial direction.

7. The airtight member as claimed in claim 1, wherein the main body is a stepped cylinder composed of an upper segment and a lower segment, the upper segment has a diameter greater than that of the lower segment, the upper segment and the lower segment have a central hole passing through the main body in the axial direction, one end of the upper segment, connected to the lower segment, has the base surface, another end of the upper segment, opposite to the lower segment, has another base surface, and the fluoroelastomer seal is bonded to each of the two base surfaces by hot pressing.

8. A manufacturing method of the airtight member as claimed in claim 1, comprising the steps of:
the main body of the airtight member being placed into a through hole of a main mold, the airtight member being held by the main mold, the base surface of the airtight member and a contact surface of the main mold being located at a same side;
a pre-pressed fluoroelastomer material being placed on the base surface or a molding surface of a forming mold, the molding surface and the contact surface being moved to come into contact with each other, the pre-pressed fluoroelastomer material being pressurized by a forming cavity recessed on the molding surface for the pre-pressed fluoroelastomer material to fill the forming cavity and to be molded between the forming cavity and the base surface, the remaining material of the pre-pressed fluoroelastomer material overflowing to an overflow space, the forming mold being heated for forming the fluoroelastomer seal bonded to the base surface.

9. The manufacturing method as claimed in claim 8, wherein the main mold includes two mold bodies that are symmetrical and can be aligned and closed, after the two mold bodies are aligned and closed, the through hole is formed for accommodating the main body of the airtight member and two opposite contact surfaces are formed, after the main body of the airtight member is placed in the through hole, the base surface of the main body is 0.5 μm to 5 μm higher than the contact surface.

10. The manufacturing method as claimed in claim 8, wherein the forming cavity is ring-shaped and is concavely formed on the molding surface of the forming mold, the forming cavity is separated from the overflow space by an annular outer peripheral wall, and the annular outer peripheral wall has a thickness of 0.07 mm to 0.50 mm.

11. The manufacturing method as claimed in claim 8, wherein the main body is a stepped cylinder composed of an upper segment and a lower segment, the upper segment has a diameter greater than that of the lower segment, the upper segment and the lower segment have a central hole passing through the main body in the axial direction, the forming cavity is ring-shaped and is concavely formed on the molding surface of the forming mold, the forming cavity is separated from the overflow space by an annular outer peripheral wall, the annular outer peripheral wall has a thickness of 0.07 mm to 0.50 mm, a retaining hole is formed in a center of the forming cavity, the retaining hole communicates with an accommodating cavity having an opening opposite to the molding surface, and the lower segment passes through the retaining hole and extends into the accommodating cavity to assist in retaining the main body.

12. The manufacturing method as claimed in claim 10, wherein the forming cavity has a semi-circular, triangular, rectangular, trapezoidal or hill-shaped longitudinal section in the axial direction, the longitudinal section of the forming cavity has a maximum depth of 0.45 mm to 1.87 mm and a maximum width of 1.01 mm to 2.35 mm.

13. The manufacturing method as claimed in claim 10, wherein the overflow space is arranged around the annular outer peripheral wall, the overflow space has an overflow channel and a storage cavity, the overflow channel is located between the annular outer peripheral wall and the storage cavity, the overflow channel communicates with the storage cavity; the overflow channel has a length of 1.5 mm to 1.9 mm and a height of 0.10 mm to 0.3 mm.

14. The manufacturing method as claimed in claim 8, wherein the fluoroelastomer seal is made of fluoroelastomer (FKM) or perfluoroelastomer (FFKM).

15. The manufacturing method as claimed in claim 8, wherein the pre-pressed fluoroelastomer material is pre-pressed into a ring shape, and the pre-pressed fluoroelastomer material has a volume greater than that of the forming cavity by 2% to 5%; and the forming mold is heated to a temperature of 130° C. to 250° C.
